(19) United States
(12) Patent Application Publication
(10) Pub. No.: US 2017/0045096 A1
(43) Pub. Date: Feb. 16, 2017

(54) CAM MECHANISM

(71) Applicant: TOYOTA JIDOSHA KABUSHIKI KAISHA, Toyota-shi, Aichi-ken (JP)

(72) Inventors: Naoyuki KISHIMOTO, Susono-shi, Shizuoka-ken (JP); Atsushi HONDA, Susono-shi, Shizuoka-ken (JP); Fusahiro TSUKANO, Susono-shi, Shizuoka-ken (JP); Hirotsugu YOSHINO, Susono-shi, Shizuoka-ken (JP)

(73) Assignee: TOYOTA JIDOSHA KABUSHIKI KAISHA, Toyota-shi, Aichi-ken (JP)

(21) Appl. No.: 15/305,475

(22) PCT Filed: Apr. 16, 2015
(86) PCT No.: PCT/IB2015/000506

§ 371 Date: Oct. 20, 2016

(30) Foreign Application Priority Data
Apr. 22, 2014 (JP) 2014-087824

(51) Int. Cl. F16D 23/12; F16D 13/52

(52) U.S. Cl. CPC F16D 23/12; F16D 13/52; F16D 2023/123; F16D 2121/14

(57) ABSTRACT

A cam mechanism includes an input member and an output member and a second cam groove is provided on a surface of the output member. The cam mechanism is configured to sandwich a rolling element accommodated in the second cam groove. The second cam groove has; a first region provided such that an inclination angle, relative to a rotary surface, of a bottom face of the second cam groove on which the rolling element makes rolling contact at the time when a phase difference is not more than a predetermined amount, is increased; and a second region provided such that the inclination angle, relative to the rotary surface, of that bottom face of the second cam groove with which the rolling element makes rolling contact at the time when the phase difference is more than the predetermined amount, is smaller than a largest inclination angle in the first region.

### BACKGROUND OF THE INVENTION

1. Field of the Invention

The present invention relates to a cam mechanism configured such that cam grooves are formed on those surfaces of two members which are opposed to each other, and a rolling element is accommodated in the cam grooves, so that the rolling element is sandwiched between the two members.

2. Description of Related Art

Japanese Patent Application Publication No. 2009-220593 (JP 2009-220593 A), Japanese Patent Application Publication No. 2009-36341 (JP 2009-36341 A), and Japanese Patent Application Publication No. 4-88260 (JP 4-88260 A) describe a ball cam mechanism configured to press a multi-plate clutch for transmitting a torque by a frictional force, so as to increase a transmission torque capacity. The ball cam mechanism described in JP 2009-220593 A changes a torque into a thrust, and transmits the thrust. A piston, which is an output member of the ball cam mechanism, is configured to press a friction material of the multi-plate clutch. Further, the ball cam mechanism described in JP 2009-220593 A is placed so that a gap between the friction material and the piston becomes large when the multi-plate clutch is released. A reason thereof is to restrain a viscous resistance of oil intervening between the friction material and the piston from acting at the time when the multi-plate clutch is released.

In the meantime, if the gap between the friction material and the piston is made large at the time when the multi-plate clutch is released, it may take a long time after an input member begins to be rotated to engage the multi-plate clutch until the friction material begins to make contact with the piston. This may decrease a response of the ball cam mechanism. In view of this, a recessed portion and an inclined portion are formed in a cam groove of the ball cam mechanism described in JP 2009-220593 A, and a boundary portion therebetween has a step. When the multi-plate clutch is released, the recessed portion accommodates a ball therein. Further, when the frictional material makes contact with the piston, the ball makes rolling contact with the inclined portion. Accordingly, when the input member begins to rotate, the ball climbs over the step and makes rolling contact with the inclined portion. This increases a ratio of a moving amount of an output member relative to a rotational amount of the input member, which makes it possible to shorten a time before the friction material makes contact with the piston. Further, in order to restrain displacement of a phase of the ball, the ball cam mechanism described in JP 2009-220593 A includes a retainer for holding a plurality of balls.

Note that, in the ball cam mechanism described in JP 2009-36341 A, a cam groove is formed so as to be gradually shallowed toward both sides of the cam mechanism in a circumferential direction. Further, in the ball cam mechanism described in JP 4-88260 A, an inclination angle of a bottom face of a cam groove in a region where a thrust is caused is formed so as to be constant.

In the meantime, in a cam mechanism configured such that a plurality of cam grooves are provided on respective surfaces of two members which surfaces are opposed to each other, such that the plurality of cam grooves are placed at a predetermined interval in a circumferential direction, and rolling elements each accommodated in each of the cam grooves are sandwiched between the two members, if a load to sandwich the rolling elements is small, a phase of any of the rolling elements may be displaced from phases of the other rolling elements. Accordingly, if the retainer for holding the rolling elements is provided as described in JP 2009-220593 in order to restrain the displacement of the phase of the rolling element, the number of components is increased, which may increase an axial length of the cam mechanism or increase a power loss due to friction between the rolling elements and the retainer.

In view of this, when the cam groove is provided so that an inclination angle of its bottom face is gradually increased, it is possible to restrain the displacement of the phase of the rolling element. However, when the cam groove is formed so that the inclination angle of the bottom face is gradually increased, a thrust of an output-side member configured to slide in an axis direction along the cam groove is gradually decreased. Accordingly, in a frictional engagement device for transmitting a torque by a frictional force, in a case where a cam mechanism is provided so that an output-side member presses to increase a transmission torque capacity of the frictional engagement device, after the output-side member makes contact with the frictional engagement device, a large thrust is required. Accordingly, if the cam groove is formed so that the inclination angle of the bottom face is gradually increased in order to restrain the displacement of the phase of the rolling element as described above, there is a possibility that a sufficient thrust to press the frictional engagement device cannot be output.

### SUMMARY OF THE INVENTION

The present invention is accomplished in view of the above circumstances, and provides a cam mechanism that is able to output a large thrust while restraining displacement of a phase of a rolling element.

In view of this, according to one aspect of the present invention, a cam mechanism including a rolling element, a first cam member, and a second cam member is provided. The first cam member includes a first cam groove. The first cam member has a shape hollowed in an axis direction of the first cam member and gradually shallowed toward one rotation direction of the first cam member from a part where a hollow depth is deepest. The first cam groove has a third region and a fourth region. The third region is a region where an inclination angle, relative to a rotary surface of the first cam member, of a bottom face of the first cam groove with which the rolling element makes rolling contact is gradually increased. The fourth region is a region where the inclination angle, relative to the rotary surface, of the bottom face of the first cam groove with which the rolling element makes rolling contact is smaller than a largest inclination angle in the third region. The second cam member includes a second cam groove. The second cam groove has a shape hollowed in an axis direction of the second cam member, which axis direction is in common with the axis direction of the first cam member, and gradually shallowed from a part where a hollow depth is deepest toward the rotation direction of the second cam member which is a rotation direction opposite to the one rotation direction of the first cam member. The second cam groove has a symmetrical shape to the first cam groove. The second cam groove has a first region and a second region. The first region is a region where an inclination angle, relative to a rotary surface of the second cam member, of a bottom face of the second cam groove with which the rolling element makes rolling contact is gradually increased. The second region is a region where the inclination angle, relative to the rotary surface, of the bottom face of the second cam groove with which the rolling element makes rolling contact is smaller than a largest inclination angle in the first region. The first cam member and the second cam member are opposed to each other in the axis direction so as to sandwich the rolling element between the first cam groove and the second cam groove, and the first cam member and the second cam member is configured to rotate relative to each other.

Further, in the cam mechanism, the cam mechanism may be configured to increase a transmission torque capacity of a frictional engagement device. The frictional engagement device may be configured to rotate the first cam member and the second cam member relative to each other, so as to move the second cam member in the axis direction and transmit a torque by a frictional force of the frictional engagement device. An end surface of the second cam member which is a surface opposite to the first cam member may be placed so as to be distanced from the frictional engagement device in the axis direction at a predetermined interval. The first region and the third region may be provided for a case where a phase difference between the first cam member and the second cam member is equal to or less than a predetermined amount. The second region and the fourth region may be provided for a case where a phase difference between the first cam member and the second cam member is more than the predetermined amount.

Further, in the cam mechanism, the third region and the fourth region may be configured to be continuous with each other in a circumferential direction of the first cam member. In the first cam groove, the second cam member may be configured to begin to make contact with the frictional engagement device at the time when the rolling element makes contact with the bottom face of the first cam groove in a boundary portion between the third region and the fourth region.

Further, in the cam mechanism, the first region and the second region may be configured to be continuous with each other in a circumferential direction of the second cam member. In the second cam groove, the second cam member may be configured to begin to make contact with the frictional engagement device at the time when the rolling element makes contact with the bottom face of the second cam groove in a boundary portion between the first region and the second region.

Further, in the cam mechanism, each of the second region and the fourth region may have a constant inclination angle.

Further, in the cam mechanism, as the phase difference is increased, each of the inclination angles in the second region and the fourth region may be gradually decreased toward the rotation direction.

In the above cam mechanism of the present invention, the first and second cam grooves are provided on opposed surfaces of the first and second cam members, the rolling element is accommodated in the first and second cam grooves, and the rolling element thus accommodated is sandwiched between the first and second cam members. Further, when the phase difference between the first cam member and the second cam member is not less than the predetermined amount, one of the cam members presses the frictional engagement device placed so as to be distanced therefrom in the axis direction at a predetermined interval, thereby increasing a transmission torque capacity of the frictional engagement device. The first and second cam grooves have the first and third regions each provided such that the inclination angle, relative to the rotary surface, of that bottom face of the cam groove on which the rolling element makes rolling contact at the time when a phase difference between the first cam member and the second cam member is not more than the predetermined amount, is increased as the phase difference is increased. Accordingly, during a period before the cam mechanism receives a large reaction force from the frictional engagement device which reaction force is caused because the second cam member presses the frictional engagement device, a load opposed to a direction in which a phase of the rolling element is displaced is applied to the rolling element from the first and second cam grooves, thereby making it possible to restrain the phase displacement of the rolling element. As a result, it is not necessary to provide a retainer or the like to adjust the phase of the rolling element, thereby making it possible to reduce the number of components and an axial length of the cam mechanism. Further, no frictional resistance is caused between the retainer and the rolling element, so that it is possible to improve load transmission efficiency of the cam mechanism. Further, it is possible to reduce a frictional resistance caused when the rolling element slips over the bottom face of the cam groove, so that a torque input into the cam mechanism or power input to cause a torque in the cam mechanism can be reduced.

Further, the cam groove includes the second region and the fourth region each provided such that the inclination angle, relative to the rotary surface, of that bottom face of the first or second cam groove with which the rolling element makes rolling contact at the time when the phase difference between the first cam member and the second cam member is not less than the predetermined amount, is smaller than a largest inclination angle in the first or third region. When the rolling element makes contact with the bottom faces of the first and second cam grooves in the second region and the fourth region, it is possible to increase a thrust output from the cam mechanism. As a result, it is possible to output a sufficient thrust to press the frictional engagement device.

Further, by providing the first and third regions and the second and fourth regions, it is possible to shorten the lengths of the first and second cam grooves as compared with a case where the inclination angles over the whole bottom faces of the first and second cam grooves are small. On that account, if the number of the first and second cam grooves to provide is increased, it is possible to reduce a contact pressure acting on the rolling element accommodated in the first and second cam grooves. As a result, rigidity of the rolling element can be reduced, that is, the rolling element can be downsized. This makes it possible to shorten an axial length of the cam mechanism. Further, the lengths of the first and second cam grooves can be shortened, thereby making it possible to place the first and second cam mechanism on an inner side. As a result, a centrifugal force acting on the rolling element accommodated in the first and second cam mechanisms can be reduced, so that it is possible to restrain the rolling element from separating outwardly. Furthermore, by shortening the lengths of the first and second cam grooves, it is possible to increase a moving amount of an output-side member with respect to a phase change amount between the first cam member and the second cam member. This makes it possible to improve a response of the cam mechanism.

Further, in a case where the second region and the fourth region are provided to have a constant inclination angle, it is possible to restrain a decrease in machining accuracy of the bottom faces of the cam grooves in the second region and the fourth region. This makes it possible to restrain a decrease in performance, such as unevenness in load to be output.

In the meantime, the inclination angles in the second region and the fourth region are provided so as to be gradually decreased toward the rotation direction, so that a load to press one of the first cam member and the second cam member in the axis direction is increased as a phase difference therebetween is increased. Hereby, when the rolling element rolls on the bottom faces of the first and second cam grooves in the first region and the fourth region to move to the bottom faces of the first and second cam grooves in the second region and the fourth region, it is possible to restrain the output-side member from suddenly moving in the axis direction.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view to describe one exemplary cam groove of a cam mechanism according to an embodiment of the present invention;

FIG. 2 is a sectional view to describe a state where a ball is sandwiched between an input member and an output member when a clutch of the cam mechanism of the embodiment is released;

FIG. 3 is a sectional view to describe a state where the ball is sandwiched between the input member and the output member when the clutch of the cam mechanism of the embodiment begins to engage;

FIG. 4 is a sectional view to describe an orientation of a load to act on one ball of which a phase is displaced from a phase of another ball, in the cam mechanism of the embodiment;

FIG. 5 is a sectional view to describe a state where the ball is sandwiched between the input member and the output member when the clutch of the cam mechanism of the embodiment completely engages;

FIG. 6 is a sectional view to describe another exemplary shape of the cam groove of the cam mechanism according to the embodiment of the present invention; and

FIG. 7 is a sectional view to describe an exemplary configuration of the cam mechanism according to the embodiment of the present invention.

### DETAILED DESCRIPTION OF EMBODIMENTS

A cam mechanism according to the present invention can be used as a thrust generation mechanism for increasing a transmission torque capacity of a conventionally known frictional engagement device such as a clutch or a brake, by pressing the frictional engagement device. The frictional engagement device is configured to transmit a torque by a frictional force.

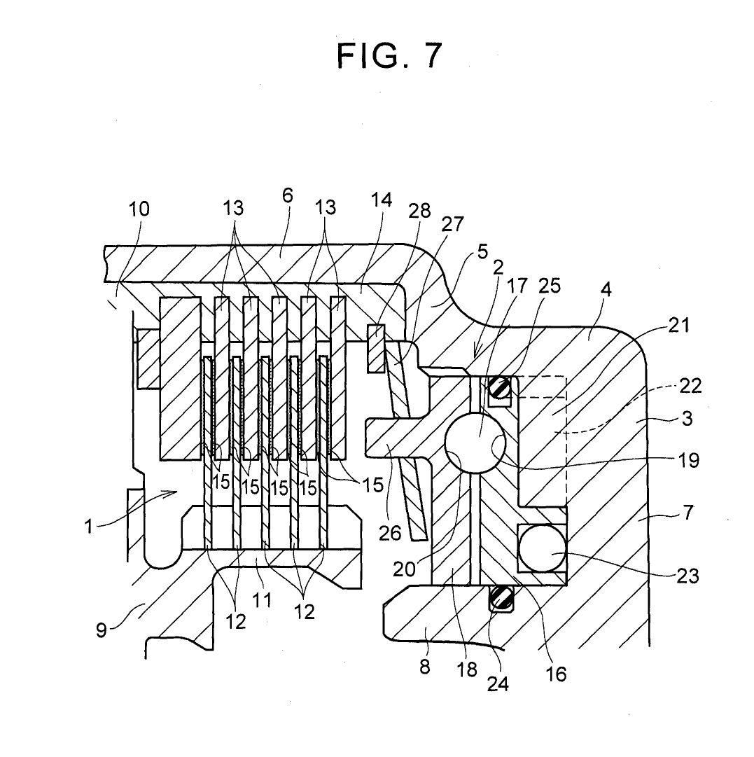

FIG. 7 illustrates an exemplary configuration in which a ball cam mechanism (also referred to as a cam mechanism) 2 gives a thrust to a conventionally known multi-plate clutch 1, so as to increase a transmission torque capacity of the multi-plate clutch 1 (also referred to as a frictional engagement device because the multi-plate clutch constitutes the frictional engagement device). The multi-plate clutch 1 formed such that a plurality of plates is placed alternately in an axis direction. The multi-plate clutch 1 and the ball cam mechanism 2 are provided inside a housing 3 of a transmission or the like. More specifically, the housing 3 includes a first cylindrical portion 4, a flange portion 5, a second cylindrical portion 6, a bottom face portion 7, and a projecting portion 8. The flange portion 5 is formed outwardly from an opening on one side of the first cylindrical portion 4. One end part of the second cylindrical portion 6 is connected to an outer peripheral part of the flange portion 5. The bottom face portion 7 closes the other side of the first cylindrical portion 4. The projecting portion 8 is a cylindrical member configured such that the projecting portion 8 is placed inside the first cylindrical portion 4 at a predetermined interval therefrom and one end part thereof is connected to the bottom face portion 7. The ball cam mechanism 2 is provided in a space between the first cylindrical portion 4 and the projecting portion 8, and the multi-plate clutch 1 is provided inside the second cylindrical portion 6.

Here, a configuration of the multi-plate clutch 1 illustrated in FIG. 7 is described briefly. The multi-plate clutch 1 illustrated in FIG. 7 is configured to selectively switch between a state where a torque is transmitted between a first rotational member 9 and a second rotational member 10 and a state where the transmission of the torque therebetween is interrupted. Here, the first rotational member 9 is an annular member connected to an input shaft (not shown), and the second rotational member 10 is an annular member connected to an output shaft (not shown). More specifically, a cylindrical first clutch drum 11 projecting in the axis direction toward the bottom face portion 7 of the housing 3 is formed on a side surface of the first rotational member 9. A plurality of drive plates 12 formed in an annular shape is placed outside the first clutch drum 11 so as to be fitted thereto in an integrally rotatable manner. The drive plates 12 are configured to transmit a torque by making contact with the after-mentioned driven plates 13, and the drive plates 12 and the driven plates 13 are placed alternately. Accordingly, the drive plates 12 are placed at a predetermined interval with a gap that allows the driven plate 13 therebetween.

In the meantime, a cylindrical second clutch drum 14 is formed on a side surface of the second rotational member 10 such that the second clutch drum 14 projects in the axis direction toward the bottom face portion 7 of the housing 3, and the second clutch drum 14 has an inside diameter larger than an outside diameter of the drive plates 12. Inside the second clutch drum 14, a plurality of driven plates 13 formed in an annular shape is placed alternately with the drive plates 12, and is fitted to the second clutch drum 14 in an integrally rotatable manner. Note that friction materials 15 are formed integrally on both side surfaces of either ones of the drive plates 12 and the driven plates 13.

Accordingly, the multi-plate clutch 1 illustrated in FIG. 7 can transmit a torque according to a load to press the drive plates 12 and the driven plates 13 and a coefficient of friction, by being pressed in the axis direction so that the drive plates 12 make contact with the driven plates 13. That is, when a load to cause the drive plates 12 to make contact with the driven plates 13 is controlled, a transmission torque capacity of the multi-plate clutch 1 is controlled. More specifically, by increasing the load to press the drive plates 12 and the driven plates 13, the transmission torque capacity of the multi-plate clutch 1 is increased.

In view of this, in the example illustrated in FIG. 7, the ball cam mechanism 2 is provided so as to control a load to press the multi-plate clutch 1. That is, the ball cam mechanism 2 is configured such that: the ball cam mechanism 2 controls the load to press the multi-plate clutch 1 is controlled according to a transmission torque capacity required for the multi-plate clutch 1; and when the multi-plate clutch 1 interrupts the transmission of the torque, the ball cam mechanism 2 separates from the multi-plate clutch 1 so that the load to press the multi-plate clutch 1 is “zero.”

The ball cam mechanism 2 illustrated in FIG. 7 is configured to convert a torque of an input member (also referred to as a first cam member) 16 into a thrust in the axis direction, so as to output the thrust from an output member (also referred to as a second cam member) 18. A plurality of cam grooves (also referred to as first cam grooves) 19 recessed in the axis direction is formed on that surface of the input member 16 which is opposed to the output member 18, such that the plurality of cam grooves 19 is arranged in a circumferential direction at a predetermined interval. A plurality of cam grooves (also referred to as second cam grooves) 20 recessed in the axis direction is also formed on that surface of the output member 18 which is opposed to the input member 16, such that the plurality of cam grooves 20 is arranged in the circumferential direction at a predetermined interval. Balls (referred to as rolling elements) 17 are configured to make rolling contact with bottom faces of those cam grooves 19, 20. More specifically, the input member 16 and the output member 18 are attached so as to sandwich the balls 17 between the cam grooves 19, 20 in a state where the balls 17 are accommodated therebetween. Note that the example illustrated herein deals with a ball cam mechanism using the balls 17, as an example. However, rollers or the like members may be used provided that they make rolling contact with the cam grooves. Further, in order to restrain the output member 18 from being inclined, it is preferable that three or more cam grooves 19 be formed in the circumferential direction at a predetermined interval, the same number of cam grooves 20 as the cam grooves 19 be formed in the circumferential direction at a predetermined interval, similarly to the cam grooves 19, and the ball 17 be provided in each of the cam grooves 19, 20.

The input member 16 illustrated in FIG. 7 is formed in an annular shape, and is fitted outside the projecting portion 8 of the housing 3 and inside the first cylindrical portion 4. The input member 16 is configured to function as an actuator for generating a torque according to a hydraulic pressure supplied from a hydraulic power source (not shown). More specifically, a plurality of wall portions 21 is formed on an outer peripheral side of the bottom face portion 7 of the housing 3, such that the plurality of wall portions 21 is arranged at a predetermined interval in the circumferential direction and projects in the axis direction. Further, a plurality of protruding portions 22 to be inserted between the wall portions 21 is formed on that end surface of the input member 16 which faces the bottom face portion 7. That is, the wall portions 21 and the protruding portions 22 are formed at a position at which they overlap with each other in the axis direction, and placed alternately in the circumferential direction. Accordingly, when oil is supplied between the wall portion 21 and the protruding portion 22, the protruding portion 22 is pressed in the circumferential direction, so as to cause a torque. Further, since the input member 16 is fitted to the projecting portion 8 so as to rotate relative to the housing 3, a thrust bearing 23 is provided between the end surface of the input member 16 and the bottom face portion 7 of the housing 3. Further, in order to restrain leakage of the oil supplied between the wall portion 21 and the protruding portion 22, seal members 24, 25 such as O-rings are provided on an inner peripheral surface and an outer peripheral surface of the input member 16. Note that in the example illustrated in FIG. 7, the input member 16 is configured to function as the actuator, but the input member 16 may be configured such that a torque is transmitted to the input member 16 from a motor (not shown) or the like.

In the meantime, the output member 18 is configured to move upon receipt of a pressing force from the input member 16 in the axis direction. In the example illustrated in FIG. 7, the output member 18 is movable in the axis direction and is attached to the housing 3 in a non-rotatable manner. More specifically, the output member 18 is formed in an annular shape, and its outer peripheral surface engages with an inner peripheral surface of the first cylindrical portion 4 by spline or the like. Note that an inner peripheral surface of the output member 18 is fitted to the projecting portion 8. Further, the output member 18 is configured to press the drive plates 12 or the driven plates 13. A cylindrical pressing portion 26 configured to press a position where the drive plates 12 and the driven plates 13 overlap with each other in a radial direction is formed on that end surface of the output member 18 which is opposite to a surface where the cam grooves 20 are formed.

As described above, the ball 17 are accommodated between the cam grooves 19, 20 formed on the input member 16 and on the output member 18. Further, when the multi-plate clutch 1 interrupts transmission of a torque, the output member 18 separates from the driven plate 13, so that a hydraulic pressure is not supplied between the protruding portion 22 and the wall portion 21. Because of this, if the output member 18 separates from the input member 16, the balls 17 separate from the cam grooves 19, 20. In view of this, in the example illustrated in FIG. 7, a return spring 27 configured to constantly press the output member 18 toward the input member 16 is provided. Note that, in the example illustrated in FIG. 7, a coned disc spring is provided as the return spring 27, but other elastic members such as a compression spring may be provided. Further, in the example illustrated in FIG. 7, a snap ring 28 for positioning an outer peripheral part of the return spring 27 is provided.

As mentioned earlier, the ball cam mechanism 2 illustrated in FIG. 7 is configured such that a torque of the input member 16 is transmitted via the balls 17, as a load to press the output member 18 in the axis direction. Accordingly, until the output member 18 makes contact with the driven plate 13, a reaction force against the load to press the output member 18 from the input member 16 is only a spring load of the return spring 27. The return spring 27 acts so as to restrain the balls 17 from separating from the cam grooves 19, 20 as described above, and is set to have a relatively small load. Further, in the example illustrated in FIG. 7, a plurality of balls 17 is provided in the circumferential direction. The cam grooves 19, 20 and the balls 17 have inevitable individual differences due to machining accuracy or the like. Accordingly, until the output member 18 makes contact with the driven plate 13, a load to sandwich the balls 17 is small. Consequently, any one of the balls 17 may slip on the cam grooves 19, 20 so that its phase may be displaced from the other balls 17. Accordingly, the cam grooves 19, 20 illustrated in FIG. 7 are configured to restrain the balls 17 from slipping in the circumferential direction.

In the meantime, when the output member 18 makes contact with the driven plate 13, a reaction force according to rigidity of the driven plate 13 acts in addition to the spring load of the return spring 27. Accordingly, the balls 17 are hard to separate from the cam grooves 19, 20, as described above. However, a load required for the output member 18 to press the driven plate 13 is large. In view of this, the cam grooves 19, 20 illustrated in FIG. 7 are configured such that, when the output member 18 makes contact with the driven plate 13, a load to press the output member 18 from the input member 16 becomes large, that is, a load to press the output member 18 against the torque from the input member 16 becomes large.

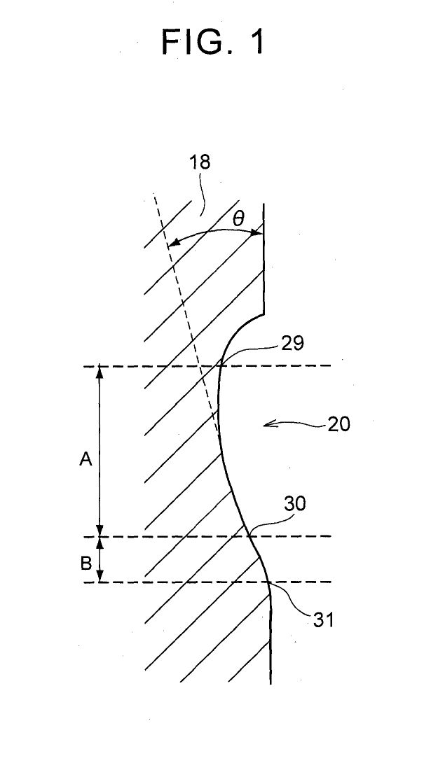

One exemplary shape of the cam grooves 19, 20 is described with reference to FIG. 1. Note that the cam groove 19 formed on the input member 16 is formed such that a depth of the cam groove 19 gradually shallows toward one rotation direction of the input member 16. The cam groove 20 formed on the output member 18 is formed in a symmetrical manner to the cam groove 19 such that a depth of the cam groove 19 gradually shallows toward a rotation direction opposite to the one rotation direction of the input member 16. Further, the cam grooves 19 formed in the input member 16 have the same shape, and the cam grooves 20 formed in the output member 18 have the same shape. In view of this, the following description deals with a shape of one of the cam grooves 20 formed in the output member 18 with reference to an example illustrated in FIG. 1, and a description of the shape of the cam grooves 19 formed in the input member 16 is omitted.

FIG. 1 is a sectional view to describe the shape of the cam groove 20. An up-down direction in FIG. 1 corresponds to the circumferential direction, and a right-left direction corresponds to the axis direction. One end part of the cam groove 20 illustrated in FIG. 1 is formed such that, when the output member 18 moves closest to the input member 16, part of an outer peripheral surface of the ball 17 makes surface contact or line contact with the one end part of the cam groove 20, so as to limit the movement of the ball 17, which will be described later. On that account, the one end part of the cam groove 20 has generally the same curvature radius as an outside diameter of the ball 17. Note that, in the following description, when the movement of the ball 17 is limited, a deepest part of that bottom face of the cam groove 20 which makes contact with the ball 17 is referred to as a first contacting portion 29.

That part of the bottom face of the cam groove 20 which is below the first contacting portion 29, as illustrated in FIG. 1, is a part with which the ball 17 makes rolling contact when a phase difference between the input member 16 and the output member 18 becomes large. More specifically, the bottom face of the cam groove 20 has a first region A formed such that the ball 17 makes rolling contact therewith before the pressing portion 26 makes contact with the driven plate 13 in a state where the output member 18 comes closest to the input member 16. Further, the bottom face of the cam groove 20 has a second region B formed such that the ball 17 makes rolling contact therewith after the pressing portion 26 makes contact with the driven plate 13 but before an engaging pressure of the multi-plate clutch 1 reaches its maximum. That is, when the phase difference between the input member 16 and the output member 18 is not more than a predetermined amount, the ball 17 makes rolling contact with the bottom face of the cam groove 20 in the first region A. When the phase difference between the input member 16 and the output member 18 is more than the predetermined amount, the ball 17 makes rolling contact with the bottom face of the cam groove 20 in the second region B.

The bottom face of the cam groove 20 in the first region A is formed such that an inclination angle of the bottom face of the cam groove 20 relative to a rotary surface of the input member 16 is gradually increased from the first contacting portion 29 toward a boundary position (hereinafter referred to as a second contacting portion 30) between the first region A and the second region B. In other words, the bottom face of the cam groove 20 in the first region A is formed such that an inclination angle relative to that end surface of the output member 18 which is opposed to the input member 16 is gradually increased from the first contacting portion 29 toward the second contacting portion 30. That is, the bottom face of the cam groove 20 is formed such that an inclination angle at the first contacting portion 29 is smallest, and an inclination angle at the second contacting portion 30 is largest, in the first region A. In other words, a curvature radius of the bottom face of the cam groove 20 in the first region A is formed so as to be gradually decreased from the first contacting portion 29 toward the second contacting portion 30. Note that, in FIG. 1, the inclination angle is indicated by “θ.”

In the meantime, the bottom face of the cam groove 20 in the second region B is formed so as to have an inclination angle smaller than the inclination angle at the second contacting portion 30. More specifically, the bottom face of the cam groove 20 in the second region B is formed so that the inclination angle is decreased as it is distanced from the second contacting portion 30. In other words, the bottom face of the cam groove 20 in the second region B is formed so that the inclination angle is decreased toward a rotation direction opposite to the rotation direction of the input member 16. Note that that end part of the second region B which is opposite to the second contacting portion 30 is referred to as a third contacting portion 31 in the following description.

Next will be described an operation of the ball cam mechanism 2 having the cam groove 20 as illustrated in FIG. 1. Note that, in the following description, that part of the cam groove 19 of the input member 16 which is formed in the same shape as the first contacting portion 29 is referred to as a fourth contacting portion 32, for convenience. That part of the cam groove 19 of the input member 16 which is formed in the same shape as the second contacting portion 30 is referred to as a fifth contacting portion 33. That part of the cam groove 19 of the input member 16 which is formed in the same shape as the third contacting portion 31 is referred to as a sixth contacting portion 34. A region where the ball 17 makes contact with the cam groove 19 of the input member 16 before the output member 18 makes contact with the driven plate 13 is referred to as a third region C. A region where the ball 17 makes contact with the cam groove 19 of the input member 16 when the output member 18 makes contact with the driven plate 13 is referred to as a fourth region D.

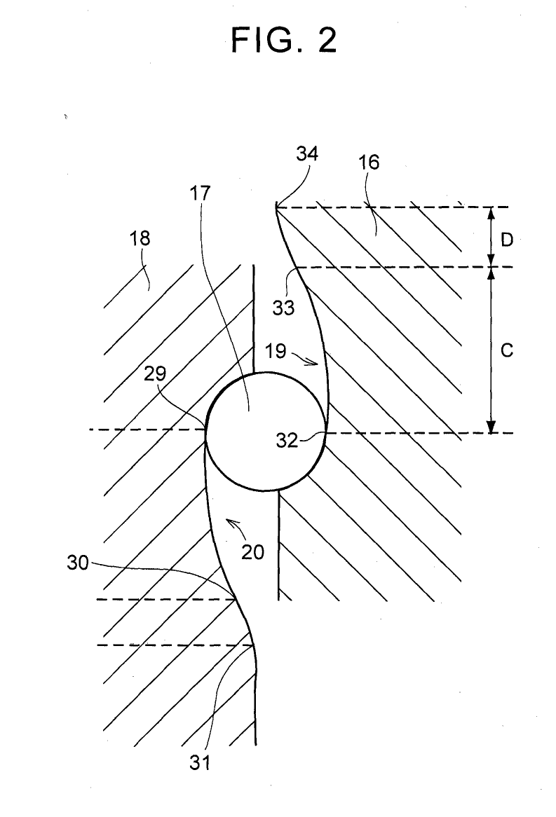

FIG. 2 illustrates a state where the output member 18 comes closest to the input member 16. More specifically, FIG. 2 illustrates a state where the ball 17 is sandwiched between the input member 16 and the output member 18 when only a spring force of the return spring 27 acts on the output member 18. Alternatively, FIG. 2 illustrates a state where the ball 17 is sandwiched between the input member 16 and the output member 18 when a load applied to the output member 18 according to a torque caused in the input member 16 is smaller than the spring force of the return spring 27. That is, FIG. 2 illustrates a state where the ball 17 is sandwiched between the input member 16 and the output member 18 when a load to press the output member 18 toward the input member 16 is larger than a load to separate the output member 18 from the input member 16.

As described above, the cam grooves 19, 20 have bottom faces formed so as to be inclined relative to end surfaces of the input member 16 and the output member 18. Accordingly, when the ball 17 makes contact with the bottom face of the cam groove 20 of the output member 18 at a position where the ball 17 does not make contact with the first contacting portion 29, a load toward the first contacting portion 29 in the circumferential direction of the output member 18 acts. This is because the output member 18 is pressed toward the input member 16, so that the load toward the first contacting portion 29 in the circumferential direction of the output member 18 is applied to the ball 17 from the bottom face of the cam groove 20 of the output member 18. When the load acts on the ball 17 as such, a load in the circumferential direction is applied from the ball 17 to the bottom face of the cam groove 19 of the input member 16 so as to press the input member 16 toward an upper side in FIG. 2. Further, the output member 18 is connected to the housing 3 in a non-rotatable manner. Accordingly, when the output member 18 is pressed toward the input member 16, the input member 16 rotates toward the upper side in FIG. 2. When the input member 16 rotates like that, a distance between the input member 16 and the output member 18 becomes larger than a diameter of the ball 17. As a result, the output member 18 moves toward the input member 16.

Note that, when input member 16 rotates as described above and the output member 18 moves in the axis direction, the ball 17 rolls on the cam groove 19 of the input member 16 and the cam groove 20 of the output member 18. Accordingly, when the load to press the output member 18 toward the input member 16 is larger than the load to separate the output member 18 from the input member 16 as described above, the ball 17 rolls to a position where the ball 17 makes contact with the first contacting portion 29 and the fourth contacting portion 32. In the following description, a state where the ball 17 makes contact with the first contacting portion 29 and the fourth contacting portion 32 is referred to as an initial state.

In the initial state illustrated in FIG. 2, when oil is supplied between the protruding portion 22 and the wall portion 21, the protruding portion 22 is pressed in the circumferential direction by a pressure of the oil thus supplied. This causes a torque in the input member 16 according to the hydraulic pressure of the oil. When the torque is caused in the input member 16 as such, a load toward a center of the ball 17 acts on that part of the ball 17 which makes contact with the bottom face of the cam groove 19. When the load acts on the ball 17 as such, the load is applied in a normal line direction of the bottom face of the cam groove 20 in that part of the ball 17 which makes contact with the cam groove 20. Since the output member 18 is connected to the housing 3 in a non-rotatable manner as described above, when the load is thus applied in the normal line direction of the bottom face of the cam groove 20, a component of the load in the axis direction presses the output member 18. As a result, the output member 18 is separated from the input member 16. Since the output member 18 is separated from the input member 16 and the load acts toward the center of the ball 17 from the bottom face of the cam groove 19 of the input member 16, the ball 17 rolls in the third region C toward the fourth region D. Then, the ball 17 rolls in the first region A toward the second region B. Note that, the output member 18 is connected to the housing 3 in a non-rotatable manner as described above, and the input member 16 is connected to the housing 3 in a relatively rotatable manner. On that account, the input member 16 rotates relative to the output member 18. Based on a phase difference between the input member 16 and the output member 18 in the initial state, when the input member 16 rotates so that the output member 18 separates therefrom, the phase difference is increased.

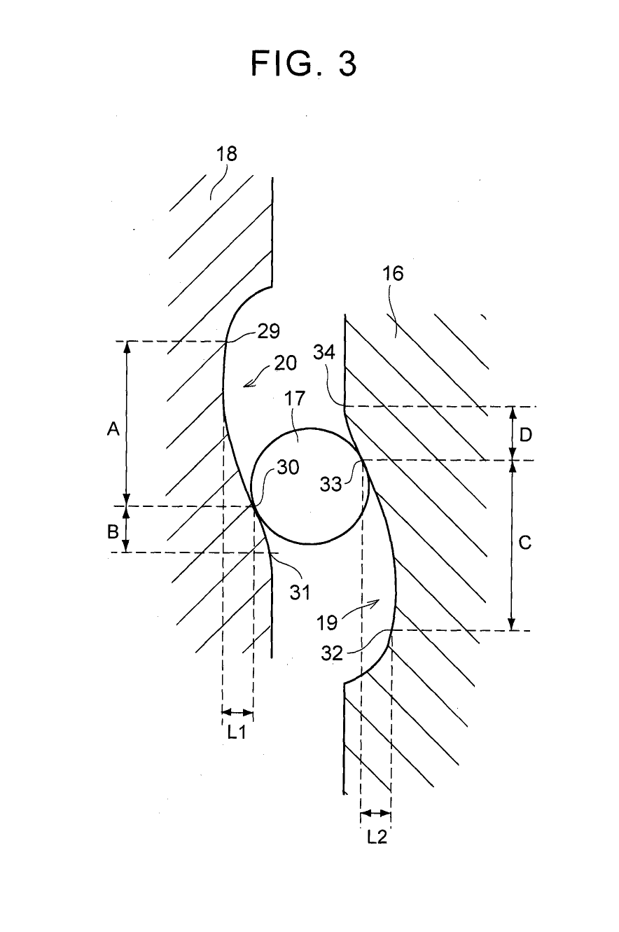

FIG. 3 illustrates a state where the ball 17 is sandwiched between the input member 16 and the output member 18 at the point when the pressing portion 26 makes contact with the driven plate 13 by the output member 18 separating from the input member 16. As described above, the second contacting portion 30 is a boundary portion between the first region A and the second region B. Similarly, the fifth contacting portion 33 is a boundary portion between the third region C and the fourth region D. At the point when the pressing portion 26 makes contact with the driven plate 13, the ball 17 makes contact with the second contacting portion 30 and the fifth contacting portion 33. That is, a deviation L1 and a deviation L2 shown in FIG. 3 are determined so that a moving amount of the output member 18 from the initial state to a state where the ball 17 makes contact with the second contacting portion 30 and the fifth contacting portion 33 is equal to a gap between the pressing portion 26 and the driven plate 13 in the initial state. The deviation L1 is a deviation distance between the first contacting portion 29 and the second contacting portion 30 in a depth direction of the cam groove 20. Further, the deviation L2 is a deviation distance between the fourth contacting portion 32 and the fifth contacting portion 33 in a depth direction of the cam groove 19.

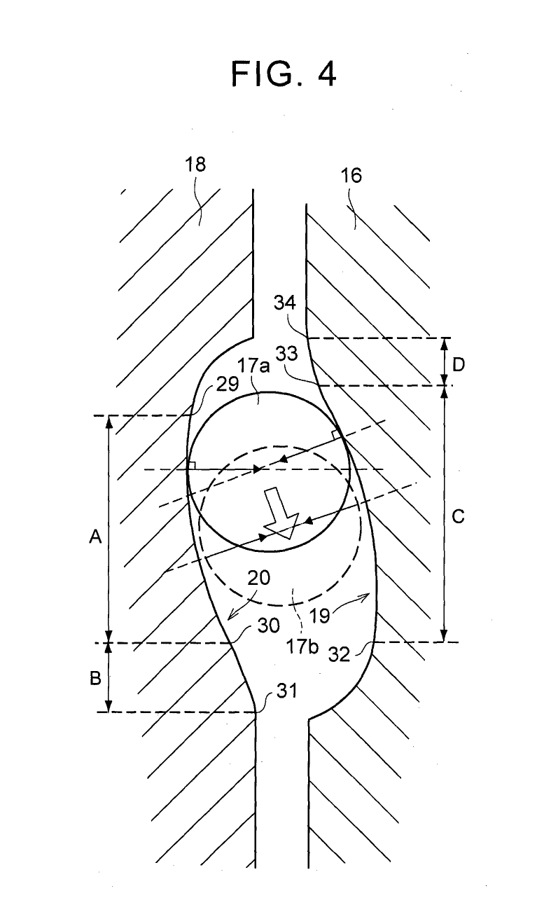

In the meantime, since a reaction force is small until the output member 18 makes contact with the driven plate 13, if the cam grooves 19, 20 and the balls 17 have machining errors, any one of the balls 17 may slip over the cam groove 19 or the cam groove 20. Accordingly, as illustrated in FIG. 1, the cam grooves 19, 20 are formed so that the inclination angles of their bottom faces in the first region A and the third region C are gradually increased, so as to restrain the slip. Here, the following describes an operation that can restrain the slip of the ball 17. Note that, in the following description, the ball 17 that slips is referred to as a first ball 17a, and the ball 17 that does not slip is referred to as a second ball 17b, for convenience. FIG. 4 illustrates a state where the first ball 17a slips and its phase is displaced from the second ball 17b. Note that a position of the second ball 17b is indicated by a broken line. More specifically, FIG. 4 illustrates the balls 17a, 17b in a case where a gap between the cam groove 19 and the cam groove 20 is large due to machining errors of the cam groove 19 or the cam groove 20, or in a case where an outside diameter of the first ball 17a is smaller than an outside diameter of the second ball 17. More specifically, FIG. 4 illustrates a state where the first ball 17a makes contact with the cam grooves 19, 20 on a side closer to the first contacting portion 29 in the first region A than the second ball 17b, and on a side closer to the fifth contacting portion 33 in the third region C than the second ball 17b.

As illustrated in FIG. 4, the ball 17 receives a load toward the center of the ball 17 from the cam groove 19. Further, a reaction force to a load of the ball 17 to press the cam groove 20 is also applied to the ball 17 from the cam groove 20 toward the center of the ball 17. Accordingly, as illustrated in FIG. 4, when no slip occurs in the ball 17, the loads applied to the second ball 17b from the input member 16 and from the output member 18 are applied thereto on the same line and in an opposed manner. This is because respective inclination angles of those parts of the cam grooves 19, 20 which make contact with the second ball 17b are the same, and a bottom face of a contacting portion in the cam groove 19 is parallel to a bottom face of a contacting portion in the cam groove 20.

In the meantime, when slip occurs like the first ball 17a illustrated in FIG. 4 and its phase is displaced from that of the second ball 17b, an orientation of a load received by the first ball 17a from the input member 16 intersects with an orientation of a load received by the first ball 17a from the output member 18. More specifically, a component, in the circumferential direction, of the load received by the first ball 17a from the input member 16 is applied in the same direction as a component, in the circumferential direction, of the load received by the first ball 17a from the output member 18. More specifically, a load in the circumferential direction acts on the first ball 17a so that the phase of the first ball 17a coincides with the phase of the second ball 17b. That is, a load acts on the first ball 17a from the input member 16 and the output member 18 in a direction opposite to a direction where the phase of the first ball 17a is displaced from the phase of the second ball 17b. In other words, when the phase is displaced like the first ball 17a, a load acts to correct the phase displacement quickly. Accordingly, the first region A and the third region C have an alignment function to align the phases of the balls 17.

Thus, when the cam grooves 19, 20 are formed so that the inclination angles of their bottom faces are gradually increased, it is possible to restrain the phases of the balls sandwiched between the cam grooves 19, 20 from being displaced, without providing a retainer or the like to align the phases of the balls 17. As a result, since it is not necessary to provide the retainer or the like, it is possible to reduce the number of components and an axial length of the ball cam mechanism 2, in comparison with a case where the retainer or the like is provided. Further, no frictional resistance or the like occurs between a member such as the retainer and the balls 17, thereby making it possible to improve load transmission efficiency. Further, as mentioned earlier, the phase displacement can be restrained, so that it is possible to decrease a frictional resistance caused because the ball 17 slips on the cam grooves 19, 20. This consequently makes it possible to reduce the hydraulic pressure to cause a torque in the input member 16.

Note that FIG. 4 illustrates a state where the first ball 17a makes contact with the cam grooves 19, 20 on a side closer to the first contacting portion 29 and the fifth contacting portion 33 than the second ball 17b. In a case where the first ball 17a makes contact with the cam grooves 19, 20 on a side closer to the second contacting portion 30 and the fourth contacting portion 32 than the second ball 17b, an upward load in FIG. 4 acts on the first ball 17a. Accordingly, the same operation and effect as above can be obtained.

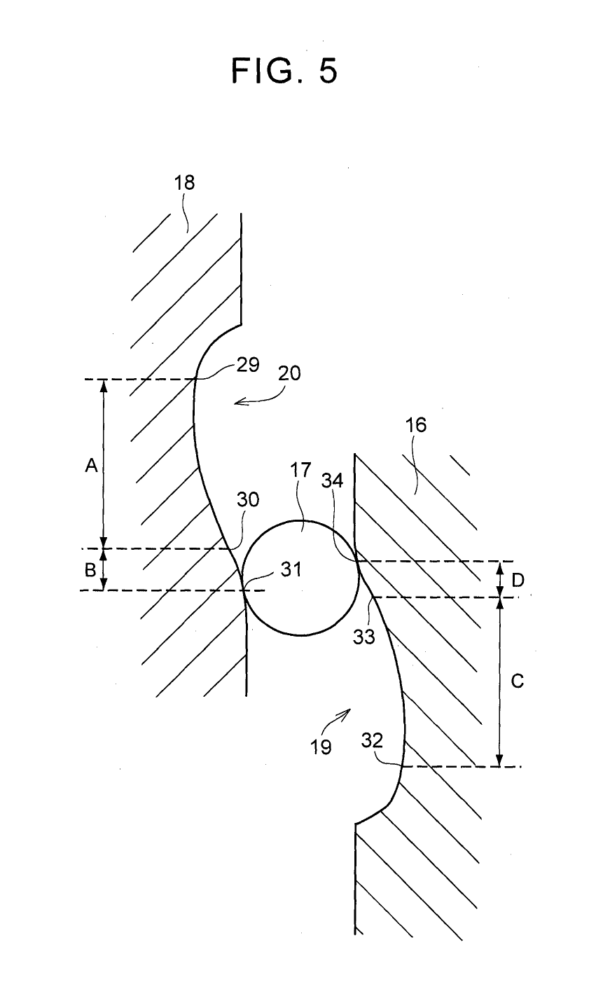

As mentioned earlier, when the output member 18 makes contact with the driven plate 13 by the ball 17 rolling on the cam grooves 19, 20 in the first region A and the third region C, a reaction force to act on the output member 18 becomes relatively large, so that the phases of the balls 17 are hard to be displaced. In the meantime, a thrust required to press the driven plate 13, that is, a load required to press the output member 18 is increased. Accordingly, as mentioned earlier, the inclination angles in the second region B and the fourth region D are formed so as to be smaller than the inclination angles of the second contacting portion 30 and the fifth contacting portion 33, so that a component, in the axis direction, of the load received by the output member 18 from the ball 17 is large, that is, so that a thrust to press the driven plate 13 is large. Further, in the example illustrated in FIG. 1, in order to restrain the output member 18 from suddenly moving when the ball 17 moves from the first region A to the second region B, the output member 18 is formed so that the inclination angle in the second region is gradually decreased toward a direction opposite to the rotation direction of the input member 16. Then, when the ball 17 rolls on the cam grooves 19, 20 in the second region B and the fourth region D and the output member 18 completely presses the driven plate 13, the ball 17 makes contact with the third contacting portion 31 and the sixth contacting portion 34 as illustrated in FIG. 5. When the output member 18 completely presses the driven plate 13 as such, a largest thrust is required. Accordingly, the cam grooves 19, 20 are formed so that the inclination angles at the third contacting portion 31 and at the sixth contacting portion 34 are smallest in the bottom faces of the cam grooves 19, 20 in the second region B and the fourth region D.

As described above, the inclination angles of the bottom faces of the cam grooves 19, 20 in the second region B and the fourth region D are made smaller than the inclination angles of the second contacting portion 30 and the fifth contacting portion 33, so that the load to press the output member 18 relative to the torque caused in the input member 16 can be increased. That is, the inclination angles of the bottom faces of the cam grooves 19, 20 in the second region B and the fourth region D are made smaller than the inclination angles of the second contacting portion 30 and the fifth contacting portion 33, so that the inclination angles of the bottom faces of the cam grooves 19, 20 in the second region B and the fourth region D are made smaller than those parts of the bottom faces of the cam grooves 19, 20 in the first region A and the third region C which have largest inclination angles. This makes it possible to increase the load to press the output member 18 relative to the torque caused in the input member 16. As a result, the hydraulic pressure to be supplied can be reduced.

Further, depths of the cam grooves 19, 20 are determined according to the gap between the output member 18 the driven plate 13, and the inclination angles of the cam grooves 19, 20 to output a largest thrust to be required are determined based on a transmission torque capacity required for the multi-plate clutch 1. Accordingly, if the inclination angles over the whole cam grooves 19, 20 are formed to inclination angles determined based on the transmission torque capacity required for the multi-plate clutch 1, lengths of the cam grooves 19, 20 in the circumferential direction may become long. However, as described above, by forming the second region B and the fourth region D continuous with the first region A and the third region C, respectively, the lengths of the cam grooves 20, 19 in the circumferential direction can be shortened. Accordingly, the number of cam grooves 19, 20 to be formed in the input member 16 and the output member 18 can be increased, thereby making it possible to decrease a contact pressure acting on each ball 17. As a result, strength of the ball 17 can be reduced, so that the outside diameter of the ball 17 can be made small. This eventually makes it possible to shorten the axial length of the ball cam mechanism 2. Alternatively, the lengths of the cam grooves 19, 20 in the circumferential direction can be shortened, so that the cam grooves 19, 20 can be formed on an inner peripheral side. This makes it possible to reduce a centrifugal force acting on the ball 17, so that it is possible to restrain the ball 17 from separating outwardly. Further, since the lengths of the cam grooves 19, 20 in the circumferential direction can be shortened, it is possible to increase a moving amount of the output member 18 per rotation amount of the input member 16. As a result, a response of the ball cam mechanism 2 can be improved.

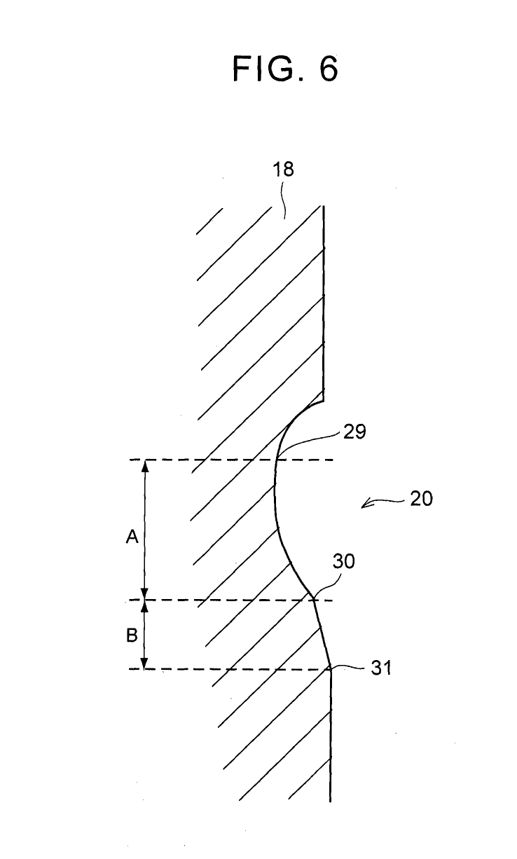

In the above example, the cam grooves 19, 20 are formed so that the inclination angles of the bottom faces thereof in the second region B and the fourth region D are gradually decreased. However, the inclination angles in the second region B and the fourth region D are not limited to the above, provided that the output member 18 can be pressed at a large load. In view of this, as illustrated in FIG. 6, the cam grooves 19, 20 may be formed so that the bottom faces thereof in the second region B and the fourth region D have the same inclination angles as the third contacting portion 31 and the sixth contacting portion 34. That is, the cam grooves 19, 20 may not have regions where their inclination angles are changed to the inclination angles to output a large load, more specifically, the inclination angles at the third contacting portion 31 and the sixth contacting portion 34.

As illustrated in FIG. 6, when the cam grooves 19, 20 are formed so that their bottom faces in the second region B and the fourth region D have the same inclination angles as the third contacting portion 31 and the sixth contacting portion 34, it is possible to restrain a decrease in machining accuracy. Consequently, it is possible to restrain a decrease in performance, such as unevenness in load to press the output member 18.

1. A cam mechanism comprising:
a rolling element;
a first cam member including a first cam groove, the first cam groove having a shape hollowed in an axis direction of the first cam member and gradually shallowed toward one rotation direction of the first cam member from a part where a hollow depth is deepest, the first cam groove having a third region and a fourth region, the third region being a region where an inclination angle, relative to a rotary surface of the first cam member, of a bottom face of the first cam groove with which the rolling element makes rolling contact is gradually increased, and the fourth region being a region where the inclination angle, relative to the rotary surface, of the bottom face of the first cam groove with which the rolling element makes rolling contact is smaller than a largest inclination angle in the third region; and
a second cam member including a second cam groove, the second cam groove having a shape hollowed in an axis direction of the second cam member, which axis direction is in common with the axis direction of the first cam member, and gradually shallowed from a part where a hollow depth is deepest toward a rotation direction of the second cam member which is a rotation direction opposite to the one rotation direction of the first cam member, the second cam groove having a symmetrical shape to the first cam groove, the second cam groove having a first region and a second region, the first region being a region where an inclination angle, relative to a rotary surface of the second cam member, of a bottom face of the second cam groove with which the rolling element makes rolling contact is gradually increased, the second region being a region where the inclination angle, relative to the rotary surface, of the bottom face of the second cam groove with which the rolling element makes rolling contact is smaller than a largest inclination angle in the first region, the first cam member and the second cam member being opposed to each other in the axis direction so as to sandwich the rolling element between the first cam groove and the second cam groove, and the first cam member and the second cam member being configured to rotate relative to each other,
wherein as a phase difference between the first cam member and the second cam member is increased, each of the inclination angles in the second region and the fourth region is gradually decreased toward the rotation direction.

2. The cam mechanism according to claim 1, wherein:
the cam mechanism is configured to increase a transmission torque capacity of a frictional engagement device;
the frictional engagement device is configured to rotate the first cam member and the second cam member relative to each other, so as to move the second cam member in the axis direction and to transmit a torque by a frictional force of the frictional engagement device;
an end surface of the second cam member which is a surface opposite to the first cam member is placed so as to be distanced from the frictional engagement device in the axis direction at a predetermined interval;
the first region and the third region are provided for a case where the phase difference between the first cam member and the second cam member is equal to or less than a predetermined amount; and
the second region and the fourth region are provided for a case where the phase difference between the first cam member and the second cam member is more than the predetermined amount.

3. The cam mechanism according to claim 2, wherein:
the third region and the fourth region are configured to be continuous with each other in a circumferential direction of the first cam member; and
in the first cam groove, the second cam member is configured to begin to make contact with the frictional engagement device at a time when the rolling element makes contact with the bottom face of the first cam groove in a boundary portion between the third region and the fourth region.

4. The cam mechanism according to claim 2, wherein:
the first region and the second region are configured to be continuous with each other in a circumferential direction of the second cam member; and
in the second cam groove, the second cam member is configured to begin to make contact with the frictional engagement device at a time when the rolling element makes contact with the bottom face of the second cam groove in a boundary portion between the first region and the second region.

5. The cam mechanism according to claim 1, wherein:
each of the second region and the fourth region has a constant inclination angle.

6. (canceled)
